(19) United States
(12) Patent Application Publication
(10) Pub. No.: US 2007/0157207 A1
(43) Pub. Date: Jul. 5, 2007

(54) Hardwired scheduler for low power wireless device processor and method for using the same

(75) Inventors: Yong-Ho Kim, Seoul (KR); Byoung-Chul Song, Seoul (KR); Tae-Ho Hwang, Seoul (KR); Seong-Dong Kim, Daegu (KR); We-Duke Cho, Suwon (KR)

Correspondence Address: SUGHRUE MION, PLLC, 2100 PENNSYLVANIA AVENUE, N.W., SUITE 800, WASHINGTON, DC, 20037, US

(73) Assignee: Korea Electronics Technology Institute

(21) Appl. No.: 11/474,417

(22) Filed: Jun. 26, 2006

(30) Foreign Application Priority Data
Dec. 29, 2005 (KR) KR10-2005-0133447

(51) Int. Cl. G06F 9/46

(52) U.S. Cl. 718/103

(57) ABSTRACT

The present invention relates to a hardwired scheduler for low power wireless device processor and a method for using the same wherein, for a processor used in a sensor node, ubiquitous small node and a wireless communication device which require a low power consumption, a storage of the currently running process and the process to be executed in priority in a list of subsequent processes to be carried out are automatically transmitted to the processor core, and the number of oscillations of the clock generator which operates the processor core is adjusted to be suitable for each process to reduce the power consumed by the processor to be applicable to devices operating on a network which require a low power consumption and small delay time.

### RELATED APPLICATIONS

The present disclosure relates to subject matter contained in priority Korean Application No. 10-2005-0133447, filed on 29 Dec. 2005 which is herein expressly incorporated by reference in its entirety.

### BACKGROUND OF THE INVENTION

1. Field of the Invention

The present invention relates to a hardwired scheduler for a low power wireless device processor and a method for using the same, and in particular to a hardwired scheduler for a low power wireless device processor and a method for using the same wherein, for a processor used in a sensor node, a ubiquitous small node and a wireless communication device which require a low power consumption, a storage of the currently running process and the process to be executed in priority in a list of subsequent processes to be carried out are automatically transmitted to a processor core, and wherein the number of oscillations of the clock generator which operates the processor core is adjusted to be suitable for each process to reduce the power consumed by the processor to be applicable to devices operating on a network which require the low power consumption and a small delay time.

2. Description of the Related Art

Generally, devices such as the sensor node and a wireless device determines a process to be subsequently carried out through a calculation using an algorithm included in a processor code in a processor which is included in the device.

FIG. 1 is a block diagram illustrating a state of a running process by an embedded operating system in a conventional device.

As shown, when a process is generated (new state, S110), the process is in a waiting state for most of the time (S130). When a scheduler is in operation due to an occurrence of an event, a process to be subsequently executed is determined among the processes in the waiting state according to a priority, an order of generation, and an operating time. When the process is assigned by the scheduler, an execution is carried out by reloading an internal register (running state, S140). In addition, a process that has completed an execution makes a transition to the waiting state (S130) or an end state (S150).

The system which is operated using an universal integrated operating system assigns more than 2% of an operating time of the processor to such scheduling of the process, and a memory required for an operation of the scheduler should be secured in a form of a variable.

FIG. 2 is a block diagram illustrating a process queue by an embedded operating system in a conventional device.

As shown, when the process is generated, the memory is secured by a process queue. Thereafter, an I/O queue is secured according to an I/O request by a CPU. In addition, a queue for an interrupt event may be assigned, and a queue representing whether a processing time is terminated may also be assigned.

Moreover, a processor used in a wireless network or a low power sensor network in particular should be capable of responding within a delay time.

FIG. 3 is a diagram illustrating an example of an assignment delay in a conventional processor.

As shown, a response delay for the event includes an interrupt processing delay, an assignment delay and a process execution time.

The assignment delay is initiated when a process occupation is possible in the interrupt processing delay, and a large delay is generated during a scheduling time for a race with other processes and a process assigning.

On the other hand, the integrated operating system calls the scheduler using a timer which generates an interrupt for each of the number of a generation of a fixed clock in the processor for a basic operation. Therefore, a fixed clock speed is always required, and the processor operates at a high arithmetic speed accordingly even when a high performance is not required.

Table 1 is shows properties for the priority, the emergency and the code length.

TABLE 1

| process type | priority | emergency | code length |
|---|---|---|---|
| network data generation | high | low | long |
| sensor interface | normal | low | short |
| connection | | | |
| network data reception | high | high | short |
| network data | high | high | short |
| transmission | | | |
| digital interface i/o | low | low | short |

The process having a sufficient processing time that is not required to be processed in urgently, for example the digital interface I/O or sensor interface connection in Table 1 is processed by the processor at a high speed due to the high arithmetic speed according to the fixed clock speed, resulting in a large power consumption. Therefore, the conventional system is not suitable for the sensor network which requires a low power consumption.

FIG. 4 is a diagram illustrating a flow of a software process scheduling of a conventional processor.

As shown, when the event occurs, process 0 stores a state thereof through an interrupt or the schedule timer (store the state of process 0, S210), and a next process to be executed is selected by referring to a descriptor table (select the next (process, S220). When process n denotes the next process to be executed, a register of the process n is restored (reload the state of the process n, S230) and the process n is then executed (execute, S240). The process 0 is in the waiting state while the process n is running. When the process n is suspended during the execution, the state of the process n is stored (store the state of the process n, S250), and a next process to be executed is selected by referring to the descriptor table (select the next process, S260). If the process 0 is selected to be executed, a register of the process 0 is restored (reload the state of the process 0, S270), and the process 0 is then executed (execute, S280). The process n is in the waiting state while the process 0 is running.

The scheduling through these processes consumes a great time during the selection of the process to be executed in priority. Moreover, since the processor operates synchronized to a high speed clock, it is disadvantageous in that the power consumption is increased for a process such as an external wireless activity monitoring which takes up a large time of devices such as the low power wireless device or the sensor network.

Therefore, a scheduler for the low power wireless device processor other than a universal scheduler is required.

### SUMMARY OF THE INVENTION

It is an object of the present invention to provide a hardwired scheduler for low power wireless device processor wherein, for a processor used in a sensor node, ubiquitous small node and a wireless communication device which require a low power consumption, a storage of the currently running process and the process to be executed in priority in a list of subsequent processes to be carried out are automatically transmitted to the processor core, and the number of oscillations of the clock generator which operates the processor core is adjusted to be suitable for each process to reduce the power consumed by the processor to be applicable to devices operating on a network which require a low power consumption and small delay time.

It is another object of the present invention to provide a method using the hardwired scheduler for low power wireless device processor.

In order to achieve the object of the present invention, there is provided a hardwired scheduler for a low power wireless device processor, comprising: a processor queue for storing a plurality of processes in a form of a process ID classified according to a priority and an emergency; a schedule timer for generating a synchronization signal; a process arbiter for determining a ranking of a process to be run in priority according to the priority based on the process ID stored in the process queue and the external interrupt; an interrupt controller for obtaining an external interrupt and transmitting the external interrupt to a process arbiter; a SFR for storing a state of the plurality of the processes including a currently running process based on the synchronization signal according to a determination of the process arbiter in a form of a descriptor table; and a register map updater for updating the register map of a process to be delivered to the processor for an execution based on the processor descriptor table stored in the SFR according to the determination of the process arbiter.

In order to achieve the object of the present invention, there is provided a hardwired scheduler for a low power wireless device processor, comprising: a processor queue for storing a plurality of processes in a form of a process ID classified according to a priority and an emergency; a schedule timer for generating a synchronization signal; the process arbiter for determining a ranking of a process to be run in priority according to the priority based on the process ID stored in the process queue and the external interrupt; an interrupt controller for obtaining an external interrupt and transmitting the external interrupt to a process arbiter; a SFR for storing a state of the plurality of the processes including a currently running process based on the synchronization signal according to a determination of the process arbiter in a form of a register map; and a register map multiplexer for multiplexing a register map of a process to be delivered to the processor for an execution of the register map stored in the SFR according to the determination of the process arbiter.

The hardwired scheduler for the low power wireless device processor of the present invention may further comprise a variable clock controller for variably determining an operating frequency of a clock to be used in the processor according to the determination of the process arbiter.

In order to achieve the object of the present invention, there is provided a method for scheduling a low power wireless device processor, the method comprising the steps of: (a) storing a plurality of processes in a form of a descriptor table classified according to a priority and an emergency thereof; (b) determining a process to be run in priority of the plurality of the processes based on an external interrupt; and (c) updating a register map of the process to be run in priority based on the descriptor table of the process to be run in priority to be transmitted to the processor.

In order to achieve the object of the present invention, there is provided a method for scheduling a low power wireless device processor, the method comprising the steps of: (a) storing a plurality of processes in a form of a register map classified according to a priority and an emergency thereof; (b) determining a process to be run in priority of the plurality of the processes based on an external interrupt; and (c) multiplexing the register map to transmit a register map of the process to be run in priority to the processor.

The step (b) further comprises (b-1) variably determining an operating frequency of a clock to be used for the processor.

### BRIEF DESCRIPTION OF THE DRAWINGS

FIG. 1 is a block diagram illustrating a state of a running process by an embedded operating system in a conventional device.

FIG. 2 is a block diagram illustrating a process queue by an embedded operating system in a conventional device.

FIG. 3 is a diagram illustrating an example of an assignment delay in a conventional processor.

FIG. 4 is a diagram illustrating a flow of a software process scheduling of a conventional processor.

FIG. 5 is a block diagram illustrating a hardwired scheduler for a low power wireless device processor in accordance with a first embodiment of the present invention.

FIG. 6 is a block diagram illustrating a hardwired scheduler for a low power wireless device processor in accordance with a second embodiment of the present invention.

FIG. 7 is a block diagram illustrating a processor arbiter of a hardwired scheduler for a low power wireless device processor in accordance with the present invention.

FIG. 8 is a block diagram illustrating an example of a weight matrix combination applied to the processor arbiter of FIG. 7.

FIG. 9 is a diagram illustrating a flow of a variable clock controller of a hardwired scheduler for a low power wireless device processor in accordance with the present invention.

FIG. 10 is a diagram illustrating an operation of a variable clock controller of a hardwired scheduler for a low power wireless device processor in accordance with the present invention.

FIG. 11 is a block diagram illustrating a variable clock controller of a hardwired scheduler for a low power wireless device processor in accordance with the present invention.

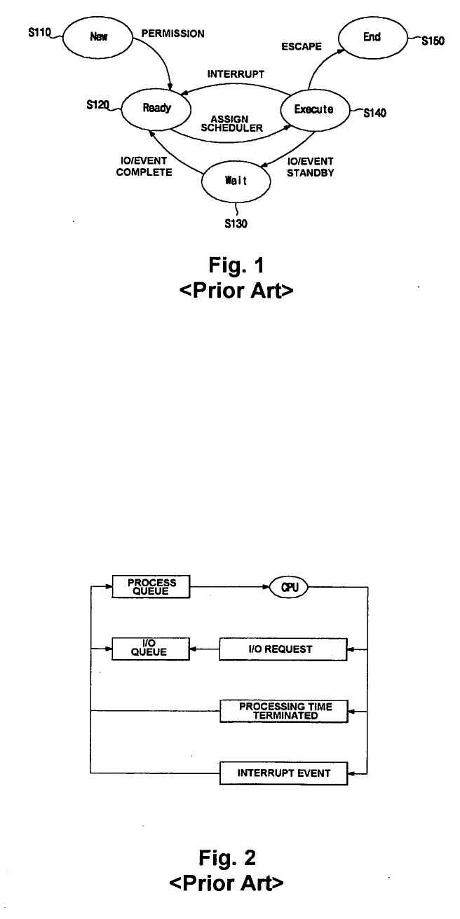

### DETAILED DESCRIPTION OF THE INVENTION

A hardwired scheduler and a scheduling method for a low power wireless device processor in accordance with the present invention will now be described in detail with reference to the accompanied drawings.

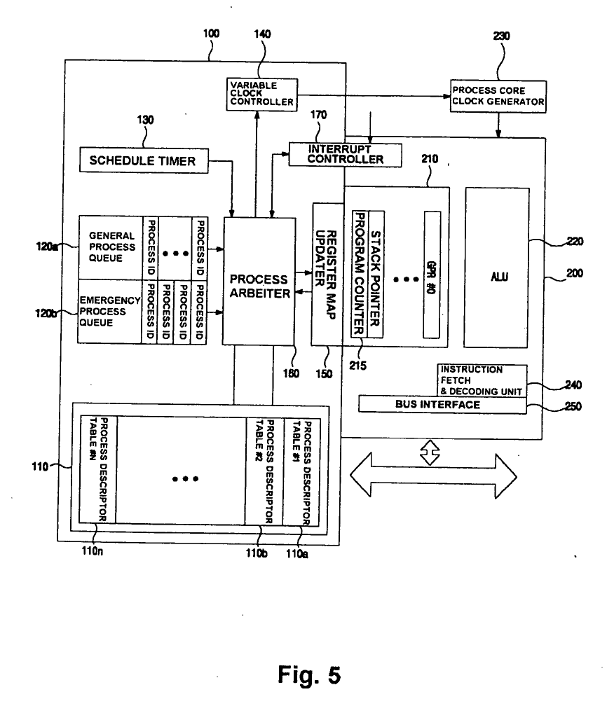

FIG. 5 is a block diagram illustrating a hardwired scheduler for a low power wireless device processor in accordance with a first embodiment of the present invention.

As shown, the hardwired scheduler 100 for the low power wireless device processor in accordance with the first embodiment of the present invention comprises a SFR 110, a process queue 120 consisting of a general process queue 120a and an emergency process queue 120b, a schedule timer 130, a variable clock controller 140, a register map updater 150, an process arbiter 160 and an interrupt controller 170. The hardwired scheduler 100 for the low power wireless device processor in accordance with the first embodiment of the present invention is connected to a processor core 200.

The SFR 110 includes a plurality of process descriptor tables 110a through 110x to store a register and an environment corresponding to each process. For such, a plurality of special function registers (“SFRs”) may be used.

The process descriptor tables 110a through 110x may be configured to include at least one of a process ID, a priority, a deadline, a frequency, a general purpose register (“GPR”), a process state, a link register (“LR”), a stack pointer (“SP”) and a program counter (“PC”) for each process.

The process queue 120 divides a general process and an emergency process and respectively stores the same in the general process queue 120a and the emergency process queue 120b in a form of the process ID.

The schedule timer 130 generates a synchronization signal.

The variable clock controller 140 controls a clock according to the process.

The process arbiter 160 selects an ID of the process which should be executed in priority according to the priority and emergency of each process stored the process queue 120.

The selected process stores a register and an environment of a currently running process in the SFR 110 in a form of the process descriptor tables 110a through 110x according to the synchronization signal generated in the schedule timer 130.

An information on the register and the environment of the process stored in the process descriptor tables 110a through 110x are then loaded in a register map 210 of the processor core 200 by the register map updater 150.

On the other hand, an interrupt which is inputted externally is obtained by the interrupt controller 170. That is, while the interrupt controller 170 is shared between the hardwired scheduler 100 and the processor core 200, the hardwired scheduler 100 in accordance with the present invention obtains the interrupt through the interrupt controller 170 to transmit the ID of the process to be executed in the processor core 200 or an address of an interrupt vector through the process arbiter 160.

More specifically, the processor core 200 has a process to be executed in the processor core 200 and other environment configuration required for the execution loaded therein, and includes the register map 210 for transmitting the process to be executed to an ALU 220 through a program counter 215.

In addition, the ALU 220 carries out an actual calculation. In this case, a processor core clock generator 230 generates a clock to be used by the processor core 200 as an operating frequency according to a control of the variable clock controller 140.

On the other hand, the processor core 200 includes an instruction fetch and decoding unit 240, and a bus interface 250. However, since such components are identical to a conventional processor core, a description in detail is thereby omitted.

As described above, the process conversion process is carried out by loading the process in the register map 210 by the register map updater 150 through two synchronization events. When the process state storing steps S210 and S250, the next process selection steps S220 and S260 or the process state reloading steps S230 and S270 which are used in the software scheduling of FIG. 4 may be omitted, thereby reducing a time necessary for the process conversion.

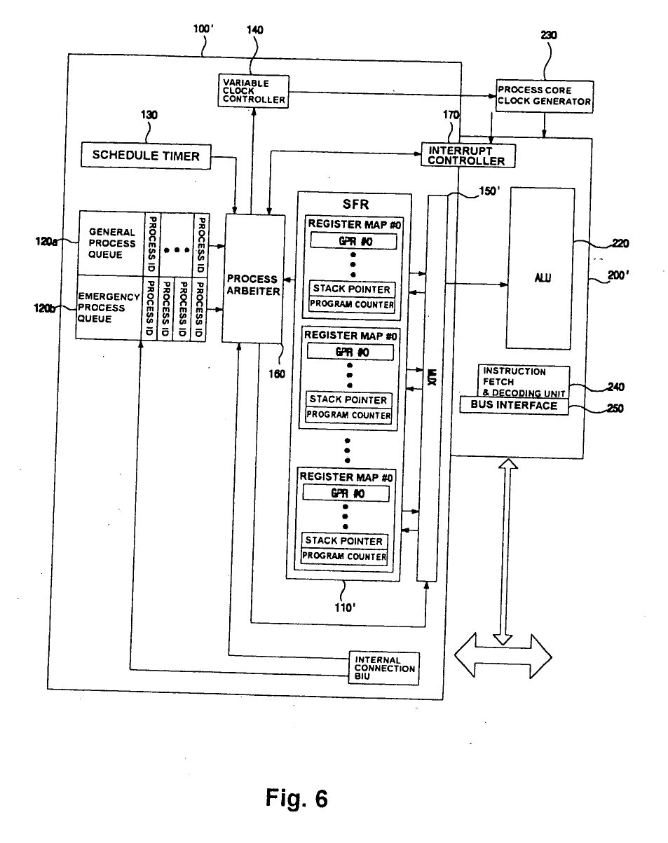

FIG. 6 is a block diagram illustrating a second embodiment of a hardwired scheduler for a low power wireless device processor in accordance with the present invention.

As shown, the hardwired scheduler 100′ for the low power wireless device processor in accordance with the second embodiment of the present invention comprises a SFR 110′, a process queue 120 consisting of a general process queue 120a and an emergency process queue 120b, a schedule timer 130, a variable clock controller 140, a register map multiplexer 150′, an process arbiter 160, an interrupt controller 170 and a internal connection bus interface 180. The hardwired scheduler 100′ for the low power wireless device processor in accordance with the second embodiment of the present invention is connected to a processor core 200′.

The SFR 110′ stores a register map corresponding to the process therein. For such, a plurality of special function registers (“SFRs”) may be used.

The register map includes at least one of a general purpose register (“GPR”), a stack pointer (“SP”) and a program counter (“PC”) information for each process.

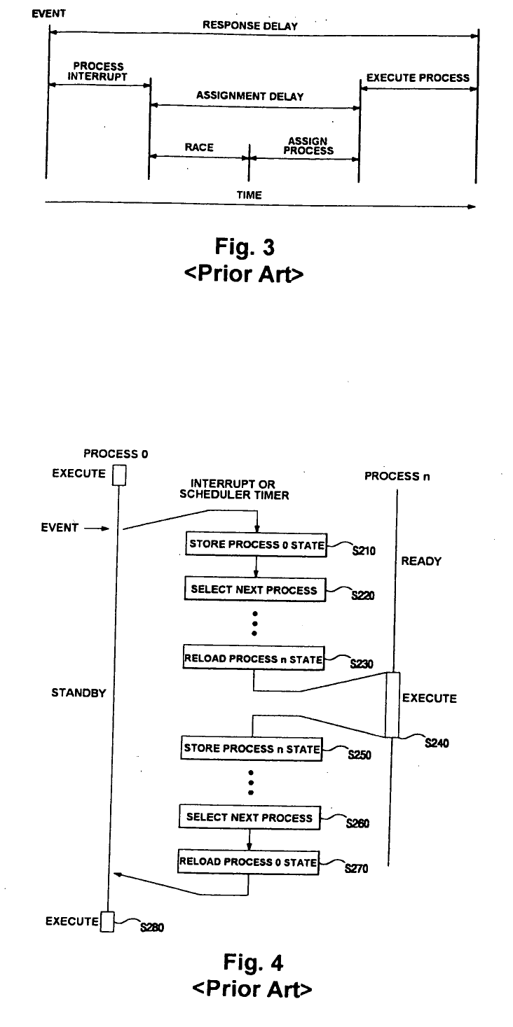

The register map multiplexer 150′ expands a register map function by a multiplexing method, and transmits the register map required by the process arbiter 160 to the processor core 200′ by the multiplexing method so that a delay generated in a process conversion process, i.e. a response delay shown in FIG. 3.

The internal connection bus interface 180 is a bus interface between the processor core 200′, the process arbiter 160 and the process queue 120.

Contrary to the hardwired scheduler 100 for the low power wireless device processor in accordance with the first embodiment of the present invention described with reference to FIG. 5, the hardwired scheduler 100′ for the low power wireless device processor in accordance with the second embodiment of the present invention stores the register map in the hardwired scheduler 100′ in the SFR 110′, and transmits the register map of the process to be executed in the processor core 200′ through the register map multiplexer 150′.

On the other hand, the processor core 200′ includes an instruction fetch and decoding unit 240, and a bus interface 250. However, since such components are identical to a conventional processor core, a description in detail is thereby omitted.

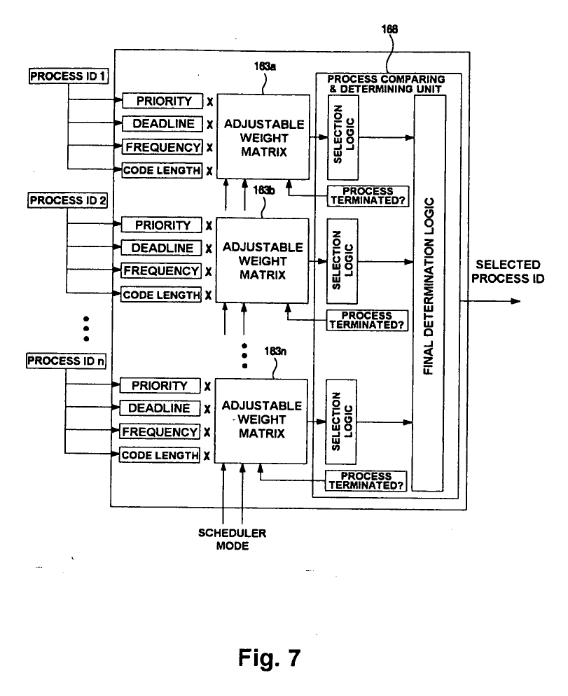

FIG. 7 is a block diagram illustrating a processor arbiter of a hardwired scheduler for a low power wireless device processor in accordance with the present invention.

As shown, the process arbiter 160 outputs the ID of the process to be executed in priority through a process comparing and determining unit 166 by considering a priority, a frequency, a deadline and a code length.

Each process is inputted to adjustable weight matrices 163a through 163n, and a weight of the weight matrices associated with a corresponding process is varied through the schedule timer 130 according to whether the corresponding process is terminated and a selection of operating mode of the scheduler.

For instance, when the corresponding process is interrupted before the corresponding process is completely terminated, the weight of the corresponding process is increased to add a higher weight during a next scheduling process so that the associated job may be completed.

The process comparing and determining unit 166 compares each process by combining of a result of the adjustable weight matrices 163a through 163n and whether the process is terminated, and then finally determines the process to be executed in priority.

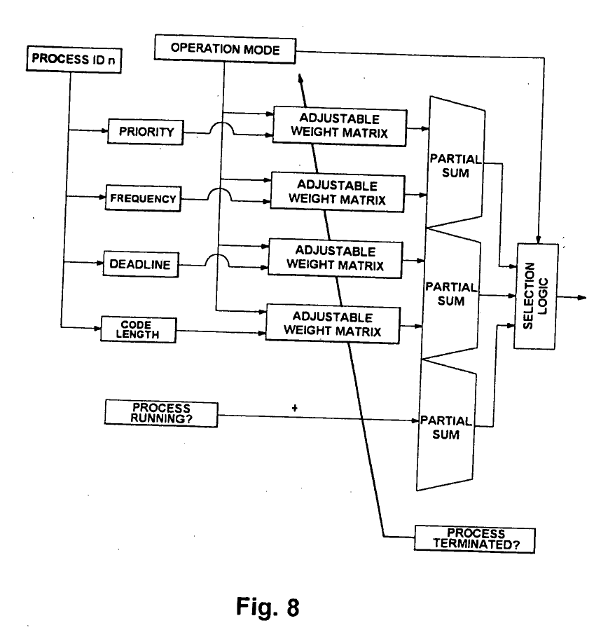

FIG. 8 is a block diagram illustrating an example of a weight matrix combination applied to the processor arbiter of FIG. 7.

As shown, each value is multiplied according to the priority, a termination, the code length and the frequency to transmit a final output. The output for each input is transmitted by calculating as a partial sum to record whether the process is currently running and whether the process is completed with out an conversion during a last process so that the conversion is minimized by increase or decreasing the variable weight during the next scheduling.

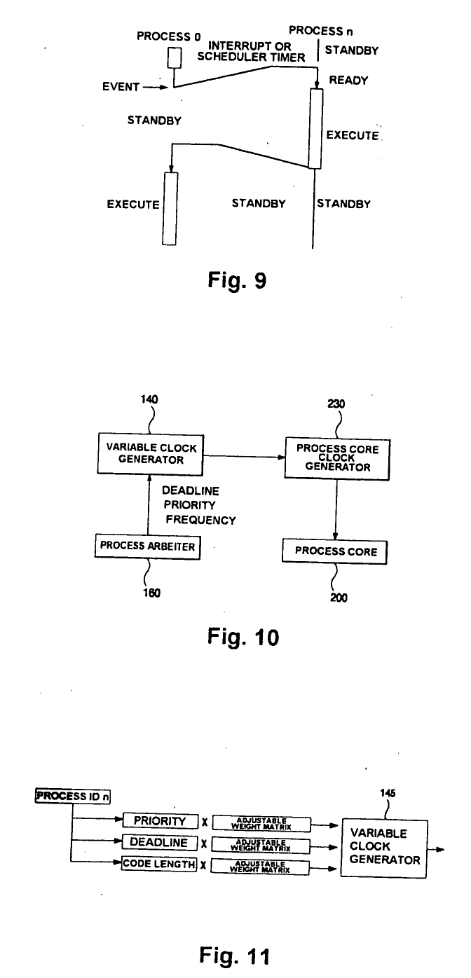

FIG. 9 is a diagram illustrating a flow of a variable clock controller of a hardwired scheduler for a low power wireless device processor in accordance with the present invention.

As shown, since an execution of a next process is prepared and carried out directly by the interrupt or the schedule timer in case of an event when the hardwired scheduler for the low power wireless device processor in accordance with the present invention is used to embody the switching of the process, a time necessary for storing the state of the process, a selection of the next process and a reload of the state of the process which occur between the switching of the process in accordance with the conventional art described with reference to FIG. 4 is greatly reduced.

FIG. 10 is a diagram illustrating an operation of a variable clock controller of a hardwired scheduler for a low power wireless device processor in accordance with the present invention.

The process arbiter 160 obtains an information such as a time at which each process is terminated, i.e. the deadline, the priority of the process, the emergency, the frequency and transmits the information to the variable clock controller 140. The variable clock controller 140 varies a clock generation frequency of the processor core clock generator 230 which generates a clock provided to the processor core 200 according to a ratio of a maximum speed of the processor to reduce a power consumption.

A power consumed in a digital electronic circuit such as the processor used generally increases exponentially as the operating frequency increases. Therefore, since an amount of an accumulated power consumption is reduced while an execution time is increased in case of carrying out the same job when the frequency used in the processor core 200 is reduced, the present invention is suitable to be applied to a sensor node or a wireless communication device which requires a long operation.

For instance, the operating frequency is increased for the high priority process to reduce the execution time, the operating frequency is decreased for the low priority process to reduce the power consumption, the process having the short code length is executed at a low operating frequency, the process having the long code length is executed at a low operating frequency, the operating frequency is decreased for the process having a long deadline to reduce the power consumption, the operating frequency is increased for the process having a short deadline to secure a completion of the process before the deadline.

Such adjustment of the operating frequency is carried out in the variable clock controller 140.

FIG. 11 is a block diagram illustrating a variable clock controller of a hardwired scheduler for a low power wireless device processor in accordance with the present invention.

As shown, the variable clock controller 140 multiplies the variable weight to the parameters such as the deadline, the priority, the code length, the emergency, the frequency of each process to generate a variable clock value through a variable clock generator 145.

In addition, the present invention provides a scheduling method using the hardwired scheduler for the low power wireless device processor described with reference to FIGS. 5 through 10.

The scheduling method using the hardwired scheduler for the low power wireless device processor differs from a conventional one in that the determination of the process to be executed subsequently is carried out through the scheduler so as to support the operation of the processor. However, a detailed description of the scheduling method is omitted since it is identical to that of the hardwired scheduler for the low power wireless device processor.

While the present invention has been particularly shown and described with reference to the preferred embodiment thereof, it will be understood by those skilled in the art that various changes in form and details may be effected therein without departing from the spirit and scope of the invention as defined by the appended claims.

As described above, in accordance with the present invention, for a processor used in a sensor node, ubiquitous small node and a wireless communication device which require a low power consumption, a storage of the currently running process and the process to be executed in priority in a list of subsequent processes to be carried out are automatically transmitted to the processor core, and the number of oscillations of the clock generator which operates the processor core is adjusted to be suitable for each process to reduce the power consumed by the processor. Therefore, the present invention is applicable to devices operating on a network which require a low power consumption and small delay time.

Particularly, a construction of a system of a wireless device having small delay which requires a real-time response is possible by reducing the delay time of a process switching through a use of the hardwired scheduler in a process switching process occurring in the scheduler. A suitable operating clock frequency is selected by calculating a time necessary for the execution of each process, which may be applied to a low power system such as a wireless network node or a sensor network node that requires a long time operation, for example more than two years.

1. A hardwired scheduler for a low power wireless device processor, comprising:
a processor queue for storing a plurality of processes in a form of a process ID classified according to a priority and an emergency;
a schedule timer for generating a synchronization signal;
a process arbiter for determining a ranking of a process to be run in priority according to the priority based on the process ID stored in the process queue and the external interrupt;
an interrupt controller for obtaining an external interrupt and transmitting the external interrupt to a process arbiter;
a SFR for storing a state of the plurality of the processes including a currently running process based on the synchronization signal according to a determination of the process arbiter in a form of a descriptor table; and
a register map updater for updating the register map of a process to be delivered to the processor for an execution based on the processor descriptor table stored in the SFR according to the determination of the process arbiter.

2. A hardwired scheduler for a low power wireless device processor, comprising:
a processor queue for storing a plurality of processes in a form of a process ID classified according to a priority and an emergency;
a schedule timer for generating a synchronization signal;
the process arbiter for determining a ranking of a process to be run in priority according to the priority based on the process ID stored in the process queue and the external interrupt;
an interrupt controller for obtaining an external interrupt and transmitting the external interrupt to a process arbiter;
a SFR for storing a state of the plurality of the processes including a currently running process based on the synchronization signal according to a determination of the process arbiter in a form of a register map; and
a register map multiplexer for multiplexing a register map of a process to be delivered to the processor for an execution of the register map stored in the SFR according to the determination of the process arbiter.

3. The hardwired scheduler in accordance with one of claims 1 or 2, further comprising a variable clock controller for variably determining an operating frequency of a clock to be used in the processor according to the determination of the process arbiter.

4. The hardwired scheduler in accordance with claim 1, wherein the descriptor table comprises at least one of the process ID, the priority, a deadline, a frequency, a general purpose register, a process state, a link register, a stack pointer and a program counter for each of the processes.

5. The hardwired scheduler in accordance with claim 2, wherein the register map comprises at least one of a general purpose register, a stack pointer and a program counter for each of the processes.

6. The hardwired scheduler in accordance with one of claims 1 or 2, wherein the processor arbiter determines the ranking of the process to be run in priority based on at least one of parameters including the priority, a frequency, a deadline and a code length of each of the processes for the plurality of the processes.

7. The hardwired scheduler in accordance with claim 6, wherein the process arbiter uses a weight matrix for the parameter to determine the ranking of the process to be run in priority.

8. The hardwired scheduler in accordance with claim 6, wherein the process arbiter applies a weight to a process incompletely terminated of the plurality of processes to determine the ranking of the process to be run in priority.

9. The hardwired scheduler in accordance with claim 3, wherein the variable clock controller variably determines the operating frequency of the clock to be used in the processor according to the determination of the process arbiter determined based on at least one of parameters including the priority, a frequency, a deadline and a code length of each of the processes for the plurality of the processes.

10. The hardwired scheduler in accordance with claim 9, wherein the variable clock controller increases the operating frequency of the processor for a high priority process to be more than a reference value and decreases the operating frequency of the processor for a low priority process to be less than the reference value.

11. The hardwired scheduler in accordance with claim 9, wherein the variable clock controller increases the operating frequency of the processor for a process having a long code length to be more than a reference value and decreases the operating frequency of the processor for a process having a short code length to be less than the reference value.

12. The hardwired scheduler in accordance with claim 9, wherein the variable clock controller increases the operating frequency of the processor for a process having a close deadline to be more than a reference value and decreases the operating frequency of the processor for a process having a far deadline to be less than the reference value.

13. The hardwired scheduler in accordance with claim 9, wherein the variable clock controller increases the operating frequency of the processor for a high frequency process to be more than a reference value and decreases the operating frequency of the processor for a low frequency process to be less than the reference value.

14. A method for scheduling a low power wireless device processor, the method comprising the steps of:
(a) storing a plurality of processes in a form of a descriptor table classified according to a priority and an emergency thereof;
(b) determining a process to be run in priority of the plurality of the processes based on an external interrupt; and
(c) updating a register map of the process to be run in priority based on the descriptor table of the process to be run in priority to be transmitted to the processor.

15. A method for scheduling a low power wireless device processor, the method comprising the steps of:
(a) storing a plurality of processes in a form of a register map classified according to a priority and an emergency thereof;
(b) determining a process to be run in priority of the plurality of the processes based on an external interrupt; and
(c) multiplexing the register map to transmit a register map of the process to be run in priority to the processor.

16. The method in accordance with one of claims 14 or 15, wherein the step (b) further comprises (b-1) variably determining an operating frequency of a clock to be used for the processor.

17. The method in accordance with claim 14, wherein the descriptor table comprises at least one of a process ID, the priority, a deadline, a frequency, a general purpose register, a process state, a link register, a stack pointer and a program counter for each of the processes.

18. The method in accordance with claim 15, wherein the register map comprises at least one of a general purpose register, a stack pointer and a program counter for each of the processes.

19. The hardwired scheduler in accordance with one of claims 14 or 15, wherein the step (b) comprises the step of (b-1) determining the process to be run in priority based on the external interrupt wherein a ranking of the process to be run in priority based on at least one of parameters including the priority, a frequency, a deadline and a code length of each of the processes for the plurality of the processes.

20. The hardwired scheduler in accordance with claim 19, wherein the step (b-1) comprises determining the ranking of the process to be run in priority by applying a weight matrix to the parameter.

21. The hardwired scheduler in accordance with claim 19, wherein the step (b-1) comprises determining the ranking of the process to be run in priority by applying a weight to a process incompletely terminated of the plurality of processes to determine the ranking of the process to be run in priority.

22. The hardwired scheduler in accordance with claim 16, wherein the step (b-1) comprises variably determining the operating frequency of the clock to be used for the processor based on at least one of parameters including the priority, a frequency, a deadline and a code length of each of the processes for the plurality of the processes.

23. The hardwired scheduler in accordance with claim 22, wherein the variably determining the operating frequency of the clock to be used for the processor based on at least one of parameters including the priority, a frequency, a deadline and a code length of each of the processes for the plurality of the processes comprises increasing the operating frequency of the processor for a high priority process to be more than a reference value and decreasing the operating frequency of the processor for a low priority process to be less than the reference value.

24. The hardwired scheduler in accordance with claim 22, wherein the variably determining the operating frequency of the clock to be used for the processor based on at least one of parameters including the priority, a frequency, a deadline and a code length of each of the processes for the plurality of the processes comprises increasing the operating frequency of the processor for a process having a long code length to be more than a reference value and decreasing the operating frequency of the processor for a process having a short code length to be less than the reference value.

25. The hardwired scheduler in accordance with claim 22, wherein the variably determining the operating frequency of the clock to be used for the processor based on at least one of parameters including the priority, a frequency, a deadline and a code length of each of the processes for the plurality of the processes comprises increasing the operating frequency of the processor for a process having a close deadline to be more than a reference value and decreasing the operating frequency of the processor for a process having a far deadline to be less than the reference value.

26. The hardwired scheduler in accordance with claim 22, wherein the variably determining the operating frequency of the clock to be used for the processor based on at least one of parameters including the priority, a frequency, a deadline and a code length of each of the processes for the plurality of the processes comprises increasing the operating frequency of the processor for a high frequency process to be more than a reference value and decreasing the operating frequency of the processor for a low frequency process to be less than the reference value.
